(19) United States
(12) Patent Application Publication
(10) Pub. No.: US 2012/0322285 A1
(43) Pub. Date: Dec. 20, 2012

(54) Waterproof Connector

(76) Inventor: Hidetaka Homme, Tokyo (JP)

(21) Appl. No.: 13/524,429

(22) Filed: Jun. 15, 2012

(30) Foreign Application Priority Data
Jun. 15, 2011 (JP) 2011-133067

(51) Int. Cl. H01R 13/52

(52) U.S. Cl. 439/271

(57) ABSTRACT

A water-proof connector includes a connector body and an outer housing surrounding the connector body and fixed to a case. The connector body has contacts and a main body housing having a main body receiving portion receiving a mating connector and holding the contacts. The outer housing includes an outer receiving portion accommodating the main body receiving portion of the connector body and receiving the mating connector with the main body receiving portion and a guide cylinder corresponding to a projection provided in the case when assembled to the case. The space between the case and the outer housing is sealed by a seal member at an outer side of the outer receiving portion.

### CROSS-REFERENCE TO RELATED APPLICATIONS

This application claims the benefit of the filing date under 35 U.S.C. §119(a)-(d) of Japanese Patent Application No. 2011-133067, filed Jun. 15, 2011.

### FIELD OF THE INVENTION

The invention relates to a water-proof connector for a device that is in contact with water.

### BACKGROUND

Conventionally, a water-proof connector is used in an electrical device that is exposed to water, such as in an engine room. As disclosed in Japanese Patent Application Laid-Open No. 10-21988, a water-proof connector has a connector body in a receiving housing that is integrally formed with a case of the electrical device. A mating connector is mated with the connector body via the receiving housing. In this water-proof connector, waterproof properties are ensured by a seal member provided between the mating connector and the receiving housing.

Japanese Patent Application Laid-Open No. 2009-9845 discloses a water-proof connector in which a connector assembled to a circuit board is assembled to a case of an electrical device via a housing separate from the case.

In the water-proof connector of Japanese Patent Application Laid-Open No. 10-21988, the connector is assembled to the receiving housing integral with the case while the mating connector is fitted to the receiving housing. Thus, the assembly tolerance between the connector, the case (the receiving housing) and the mating connector is somewhat small so as to ensure continuity between the connector and the mating connector. For this reason, each of those components has high dimension accuracy and high assembly accuracy, thereby increasing manufacturing precision and associated cost.

In the water-proof connector of Japanese Patent Application No. 2009-9845, the connector is divided into a board connector assembled to the circuit board and an outer housing assembled to the case. The outer housing has a receiving portion in which a connector housing holding contacts of the board connector is inserted. The case, the housing and the board connector are assembled in a space between the connector housing and the receiving portion of the outer housing, and in a space between the outer housing and the case such that there is a certain clearance in each of those spaces. Thus, the assembly tolerance between the case and the connector is absorbed due to the assembly tolerance between the board connector and the housing, and the assembly tolerance between the housing and the case.

However, in order to make the inside of the case water-proof, two seal members are required: one to seal between the case and the outer housing; and the other to seal between the outer housing and the connector housing. Furthermore, four bolts are required to fix the connector to the device case. This leads to an increase in cost.

There is thus a need to provide a water-proof connector that overcomes the technical problems described above.

### SUMMARY

An object of the invention is to provide a water-proof connector that can reduce cost by absorbing the assembly tolerance and reducing the number of parts for waterproofing the connector. The invention provides a water-proof connector connected to a circuit board placed in a case and assembled to the case. The water-proof connector has a connector body and an outer housing that surrounds the connector body and is fixed to the case. The connector body has a contact that establishes an electrical connection with a mating connector and a main body housing that has a main body receiving portion receiving the mating connector and holds the contact. The outer housing has an outer receiving portion that accommodates the main body receiving portion of the connector body and receives the mating connector together with the main body receiving portion, and a guide that corresponds to a case side guide provided to the case when the guide is attached to the case. A space between the case and the outer housing is sealed by a seal member at the outside of the outer receiving portion.

### BRIEF DESCRIPTION OF THE DRAWINGS

The invention is described in more detail in the following with reference to the embodiments shown in the drawings. Similar or corresponding elements in the Figures are provided with the same reference numerals. The invention will be described in detail with reference to the following figures of which:

FIG. 1 is a perspective view of a water-proof connector with a female connector connected;

FIG. 2 is a longitudinal cross-sectional view of the water-proof connector shown in FIG. 1;

FIG. 3 is a perspective view of a connector body;

FIGS. 4A through 4C is a series of views of the connector body. FIG. 4A is a plan view. FIG. 4B is a side view. FIG. 4C is a rectional view taken along line of c-c in FIG. 4A;

FIG. 5 is a longitudinal cross-sectional view of the water-proof connector unconnected with a mating connector;

FIG. 6A is a plan view of the connector shown in FIG. 5;

FIG. 6B is a longitudinal cross-sectional view of the outer housing;

FIGS. 7A and 7B are views of a procedure for manufacturing the water-proof connector;

FIGS. 8A and 8B are views of a procedure for manufacturing the water-proof connector;

FIGS. 9A and 9B are views of a procedure for manufacturing the water-proof connector; and

FIGS. 10A and 10B are views of a procedure for manufacturing the water-proof connector.

### DETAILED DESCRIPTION OF THE EMBODIMENT(S)

Illustrative embodiments of the invention will be described hereinafter in detail with reference to the attached drawings, wherein the like reference numerals refer to the like elements. The invention may, however, be embodied in many different forms and should not be construed as being limited to the embodiments set forth herein.

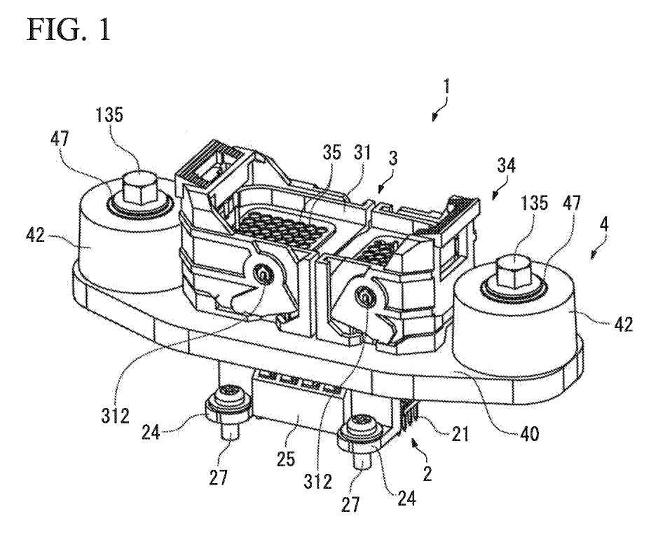

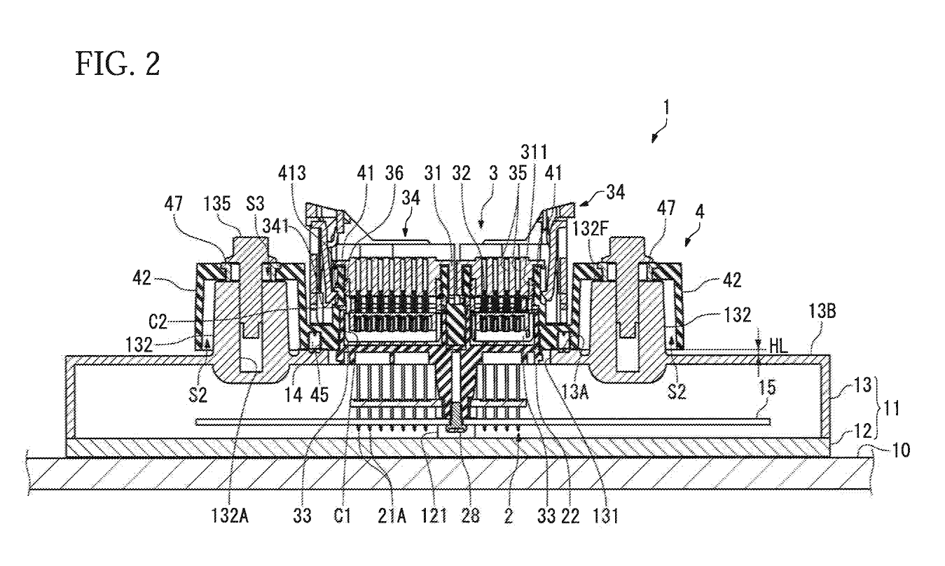

Referring to FIGS. 1 and 2, a water-proof connector 1 is assembled to a case 11 of an electrical device 10 and connected with a mating connector 3. The water-proof connector 1 includes a connector body 2 receiving contacts 21 and an outer housing fixing the connector body 2 to the case 11. It is to be noted that, in the water-proof connector 1, the side at which the water-proof connector 1 is connected with the mating connector 3 is defined as front, and the side from which an unshown electric wire is drawn is defined as rear. The same applies for the mating connector 3 wherein the side at which the mating connector 3 is connected with the water-proof connector 1 is defined as front.

The water-proof connector 1 is assembled to the case 11 of the electrical device 10, as shown in FIG. 2. The case 11 includes a support plate 12 supporting a circuit board 15 electrically connected to the water-proof connector 1 and a metal cover housing 13 fixed to the support plate 12 and covering a part of the connector body 2 and the circuit board 15.

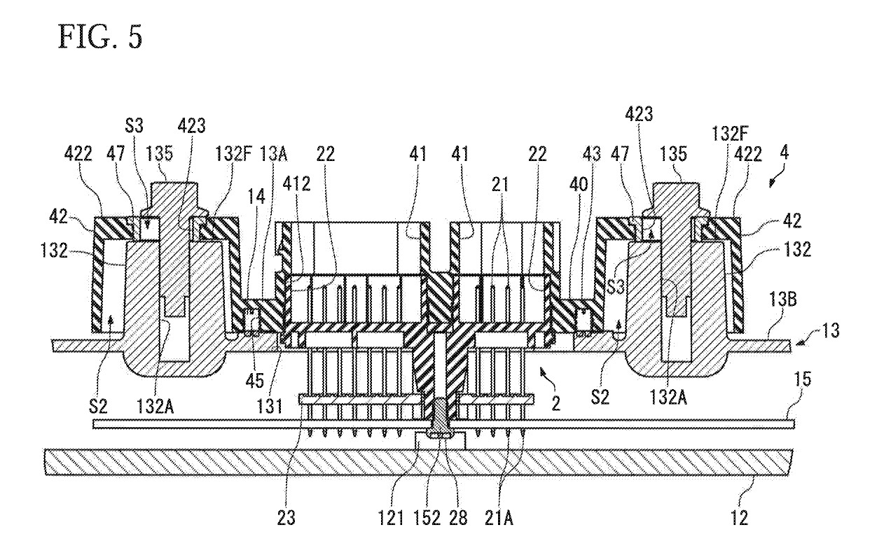

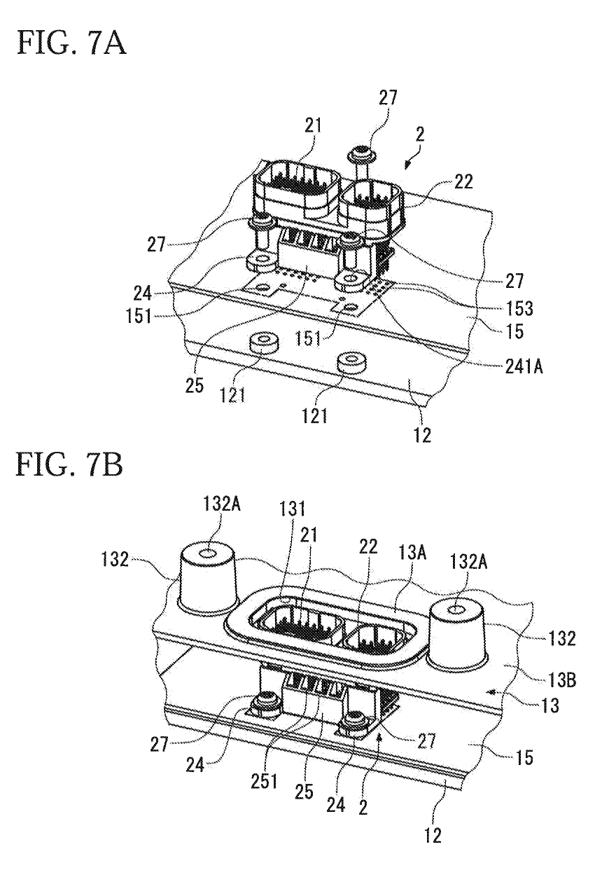

Circuit board 15 has a bolt hole 151 as shown in FIG. 7A and a bolt hole 152 as shown in FIG. 5 through which a bolt 27 or 28 fixing the connector body 2 is passed. In the support plate 12, a projection 121 as shown in FIG. 7A to which the bolt 27 is fastened is formed so as to correspond to the bolt hole 151. On the circuit board 15, various electrical elements and wiring patterns that are not shown are mounted.

Referring to FIG. 2, in the cover housing 13, a rectangular connector placement window 131 to which the connector body 2 is placed is formed. The connector body 2 passes through the connector placement window 131 to be partly accommodated in the cover housing 13 and be partly exposed to the outside of the cover housing 13.

In the cover housing 13, a ring-shaped seal surface 13A as shown in FIG. 7B is formed in the circumference of the connector placement window 131. When the assembly of the water-proof connector 1 is completed, a seal member 14 as described below is pressed against the seal surface 13A. The seal surface 13A is formed to have a height toward the front higher than a reference surface 13B in the circumference of the seal surface 13A. Specifically, a level difference HL as shown in FIG. 2 is provided between the seal surface 13A and the reference surface 13B.

Referring to FIG. 7B, in the cover housing 13, a pair of projections (case side guides) 132 are provided to project on opposite sides of the connector placement window 131 interposed between the projections. Each projection 132 is a columnar body having a top surface 132F as shown in FIG. 5. In the projection 132, a bolt hole 132A to which a bolt (fastening member) 135 as shown in FIG. 5 and described below is fastened is formed from the top surface 132F toward the lower side. The projection 132 is formed so as to be taller toward the front than the connector body 2 placed at a certain position of the cover housing 13. With such configuration and more details described below, the projection 132 functions as a guide with respect to the outer housing 4 when assembling the outer housing 4 to the cover housing 13.

The seal member 14 is shown in an uncompressed state in each figure so as to facilitate understanding of its shape. The same applies to a seal member 36 as described below.

The water-proof connector 1 includes the connector body 2 and the outer housing 4.

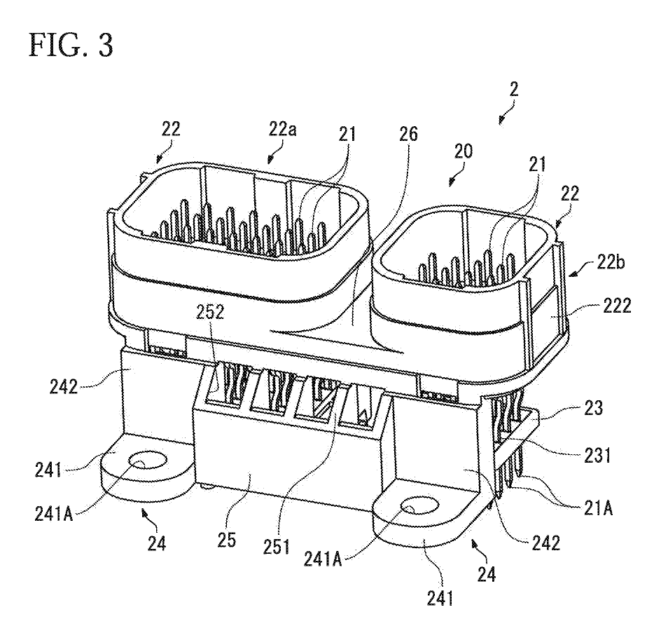

Referring to FIG. 3, the connector body 2 includes a main body housing 20 and a plurality of male contacts 21 accommodated in the main body housing 20. The main body housing 20 is a molded product of insulating resin and includes a main body receiving portion 22 surrounding a front end side of the contact 21 and a pin organizer 23 positioning the plurality of contacts 21. The main body housing 20 also includes a plurality of fixing portions 24 positioned at a rear end side from the main body receiving portion 22 and fixing the connector body 2 to the circuit board 15, and a wall body 25 provided between the adjacent fixing portions 24, 24.

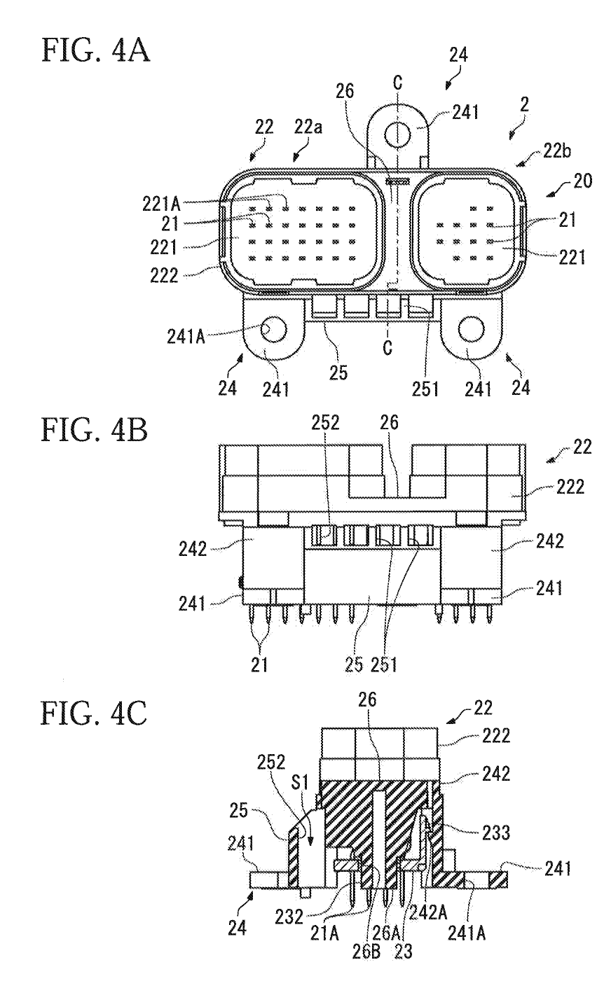

Referring to FIGS. 4A through 4C, the main body receiving portion 22 includes a holding portion 221 formed with a holding hole 221A to hold the contact 21 passing therethrough and a hood portion 222 standing from the periphery of the holding portion 221 toward the front. The contact 21 at the front end side from the held portion is accommodated in a space surrounded by the hood portion 222 and the contact 21 at the rear end side from the held portion is exposed to the inside of the cover housing 13 of the case 11. The main body receiving portion 22 is divided into a main body receiving portion 22a and a main body receiving portion 22b, which are connected by a coupling portion 26. As shown in FIG. 4C, the coupling portion 26 includes a protrusion 26A protruding toward the rear end side. The protrusion 26A is formed with a thread groove 26B opened to a rear end surface.

As shown in FIG. 2, the main body receiving portion 22 projects to the inside of the cover housing 13 through the connector placement window 131 when the connector body 2 is placed in the certain position of the cover housing 13.

Referring to FIG. 3, the pin organizer 23 is formed with a plurality of positioning holes 231 through which the contacts 21 are passed. The plurality of contacts 21 are passed through the corresponding positioning holes 231 and are thereby aligned in a certain position to be connected to the circuit board 15. Referring to FIG. 4C, the pin organizer 23 is formed with a through hole 232 through which the coupling portion 26 is passed. A locking protrusion 233 is integrally provided with the pin organizer 23 and engaged with a locking protrusion 242A of an erect portion 242, thereby preventing the pin organizer 23 from falling off. The locking protrusion 242A is formed on the inner surface of the erect portion 242.

Referring back to FIG. 3, the fixing portion 24 includes a joint portion 241 along the circuit board 15 and the erect portion 242 standing from the joint portion 241 toward the front. The joint portion 241 is formed with a bolt hole 241A through which a bolt 27 as described below is passed.

Referring to FIGS. 3, 4B and 4C, the wall body 25 functions as a heat reservoir in soldering of the connector body 2 described below. As shown in FIG. 4C, the wall body 25 has a space S1 between the wall body 25 and the contact 21 aligned at one end in the width direction of the pin organizer 23. The wall body 25 is formed along the front-rear direction of the connector body 2 from a position opposed to the joint portion 241 side of the fixing portion 24 to a rear end of the main body receiving portion 22. The space (space S1) between the wall body 25 and the contact 21 is partitioned by a plurality of fins 251. An outlet 252 for air inside of the wall body 25 is formed at an upper end (downstream end of the heat reservoir) in the inside of the wall body 25.

Referring to FIG. 5, the outer housing 4 is a molded product made of insulating resin and includes a plate-shaped cover portion 40 covering a certain portion of the case 11 (the cover housing 13), an outer receiving portion 41 standing from the cover portion 40 toward the front, and a pair of guide cylinders (guides, cylindrical bodies) 42 positioned at opposite sides of the outer receiving portion 41 to have the outer receiving portion 41 interposed between the guide cylinders 42.

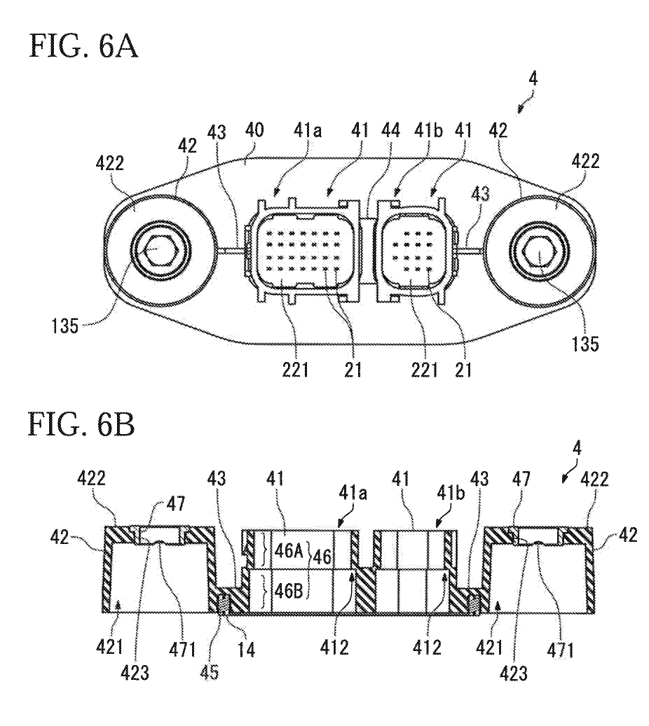

Referring back to FIG. 2, the outer receiving portion 41 is fitted with the mating connector 3. When the outer housing 4 is assembled to the cover housing 13 (the case 11), the outer receiving portion 41 accommodates the main body receiving portion 22. For this reason, the outer receiving portion 41 is provided with an accommodating cavity that passes through in the front-rear direction. As shown in FIG. 6, the outer receiving portion 41 is divided into an outer receiving portion 41a and an outer receiving portion 41b to correspond to the main body receiving portion 22.

As shown in FIG. 6B, the accommodating cavity 46 is divided into a front end area 46A having a relatively small size in the cross section and a rear end area 46B having a relatively large size in the cross section. In the boundary of the front end area 46A and the rear end area 46B, a step 412 is placed. The mating connector 3 fitted to the outer receiving portion 41 is accommodated from the front end area 46A to the rear end area 46B, specifically, from the front end of the front end area 46A to a position adjacent to a rear end of the rear end area 46B.

The main body receiving portion 22 is accommodated in the rear end area 46B. The inner surface of the main body receiving portion 22 thus accommodated is flush with the inner surface of the outer receiving portion 41, and the main body receiving portion 22 and the outer receiving portion 41 receive the mating connector 3.

Referring back to FIG. 2, the main body housing 20 and the outer housing 4 are formed so that a certain clearance C1 as shown in FIG. 2 is provided in the width direction between the main body receiving portion 22 and the outer receiving portion 41 and a certain clearance C2 as shown in FIG. 2 is provided in the front-rear direction.

Referring to FIGS. 5 and 6B, the guide cylinder 42 is provided with an accommodating space 421 that accommodates the projection 132 of the case 11 (the cover housing 13). The guide cylinder 42 has an opening at a rear end side of the accommodating space 421. The projection 132 passes the opening and then is accommodated in the accommodating space 421. At the front end side of the accommodating space 421, a fixing wall (upper wall) 422 formed with an insertion hole 423 through which the bolt 135 (convex portion) as shown in FIG. 5 fixing the outer housing 4 to the case 11 is provided. The fixing wall 422 is opposed to the top surface 132F of the projection 132.

Further referring to FIG. 5, the outer housing 4 and the cover housing 13 are formed so that a space S2 is provided between the inner surface of the guide cylinder 42 and the outer surface of the projection 132 when the outer housing 4 is assembled to the case 11.

In the inside of the insertion hole 423 of the fixing wall 422, a collar 47 made from metal is fixed along the axial direction of the guide cylinder 42. The size for the collar 47 and the bolt 135, respectively, is determined so that a space S3 in the radial direction is provided between the bolt 135 passing through the collar 47 and the collar 47 is in a state in which the outer housing 4 is fixed to the case 11 with the bolt 135. Between the collar 47 and the top surface 132F of the projection 132, a notch 471 communicating the inner portion and outer portion of the collar 47 is formed, as shown in FIG. 6B. The notch 471 is placed in three parts in the circumferential direction of the collar 47 with a certain space provided therebetween.

The outer receiving portions 41, 41 and the guide cylinders 42, 42 are placed along the longitudinal direction of the outer housing 4, as shown in FIG. 6A. The outer receiving portions 41, 41 and the guide cylinders 42, 42 are connected with each other by the cover portion 40.

Referring to FIG. 5, on a surface of the cover portion 40 opposed to the cover housing 13, a seal groove 45, which is ring-shaped in plan view, is formed so as to surround the circumference of the outer receiving portion 41. The seal member 14 is inserted into the seal groove 45. When the outer housing 4 is assembled to the cover housing 13, the seal member 14 is firmly attached to the seal surface 13A of the cover housing 13, thereby sealing between the cover portion 40 (the outer housing 4) and the cover housing 13 of the case 11 and ensuring waterproofness of the inside of the cover housing 13.

Referring to FIGS. 6A and 6B, between the guide cylinder 42 and the outer receiving portion 41 adjacent to each other, ribs 43, 44 are formed to extend along the longitudinal direction of the outer housing 4. The rib 44 reinforces the outer receiving portion 41 and also functions as a stopper surface against which a part of the mating connector 3 is abutted.

As shown in FIGS. 1 and 2, the mating connector 3 includes a housing 31 corresponding to the main body receiving portion 22 and the outer receiving portion 41, female contacts 32 held by the housing 31 and electrically connected to the contacts 21 of the water-proof connector 1, a retainer 33 buffering force acting when the connector is inserted and removed, and a lever engaging portion 34 provided in the circumference of the housing 31 and engaged with the outer housing 4 by operating a lever.

In the housing 31, contact cavities 35 to which the contacts 21 of the connector body 2 are inserted are formed. In the contact cavities 35, unshown wires electrically conducted to the contacts 32 are inserted.

The housing 31 is accommodated in a portion from the outer receiving portion 41 to the main body receiving portion 22 when the mating connector 3 and the water-proof connector 1 are connected. In short, the mating connector 3 is received by the outer receiving portion 41 and the main body receiving portion 22. The outer periphery of the housing 31 at the rear end side thereof is provided with a holding area 311 holding the seal member 36 at the entire periphery. The ring shaped seal member 36 is placed in the holding area 311. When the mating connector 3 is received in the outer receiving portion 41 and the main body receiving portion 22, the seal member 36 is firmly attached to the inner surface of the outer receiving portion 41 to fit the mating connector 3 into the outer housing 4, thereby forming a seal between the mating connector 3 and the outer housing 4. Accordingly, water is prevented from entering from the spaces between the water-proof connector 1, the mating connector 3, and the outer housing 4.

Furthermore, in the outer periphery of the housing 31, a support protrusion 312 is provided to function as an axis for the rotation of the lever engaging portion 34. The lever engaging portion 34 is rotated with the support protrusion 312 as an axis and includes an engaging protrusion 341 engaging with the engaging protrusion 413 provided in the outer periphery of the outer receiving portion 41. With such configuration, the mating connector 3 and the outer housing 4 are prevented from falling off from each other while the mating connector 3 and the connector body 2 are also prevented from falling off from each other.

The procedures for assembling the water-proof connector 1 are described below with reference to FIGS. 7A to 10B.

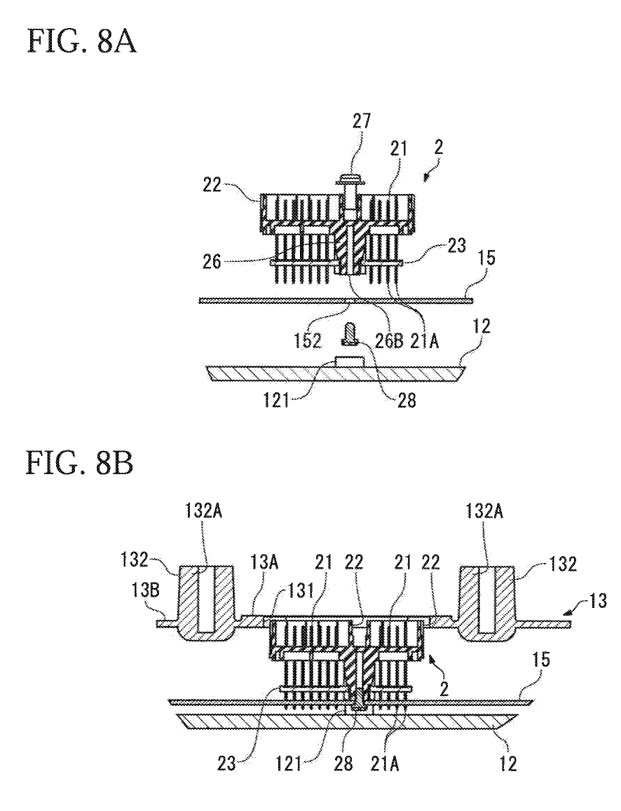

First, as shown in FIGS. 7A and 8A, the connector body 2 and the circuit board 15 are assembled to the support plate 12. At this time, as shown in FIG. 8A, a bolt 28 inserted into the bolt hole 152 of the circuit board 15 is fixed to the thread groove 26B of the coupling portion 26 of the connector body 2. Also, as shown in FIG. 7A, the bolt 27 passed through the bolt hole 241A of the fixing portion 24 of the connector body 2 and the bolt hole 151 of the circuit board 15 is screwed into a threaded hole formed in the projection 121 of the support plate 12 to fix the connector body 2 and the circuit board 15 to the support plate 12.

Next, a joint end 21A as shown in FIG. 8B of the contact 21 of the connector body 2 is soldered to a terminal 153 as shown in FIG. 7A of the circuit board 15. Hot air is blown to heat (preheat) the joint end 21A to be soldered and the circuit board 15 in advance of soldering to expedite the soldering operation.

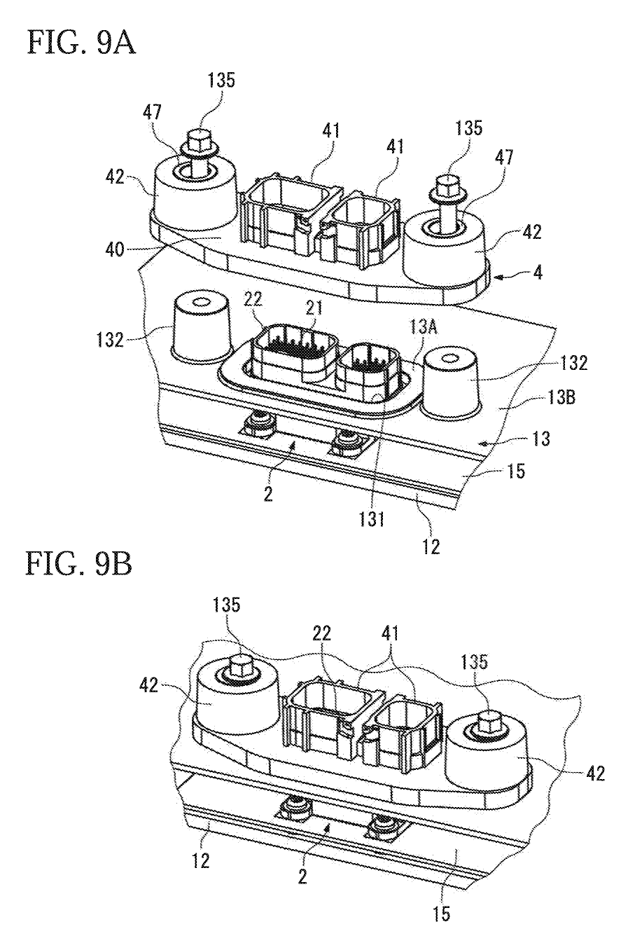

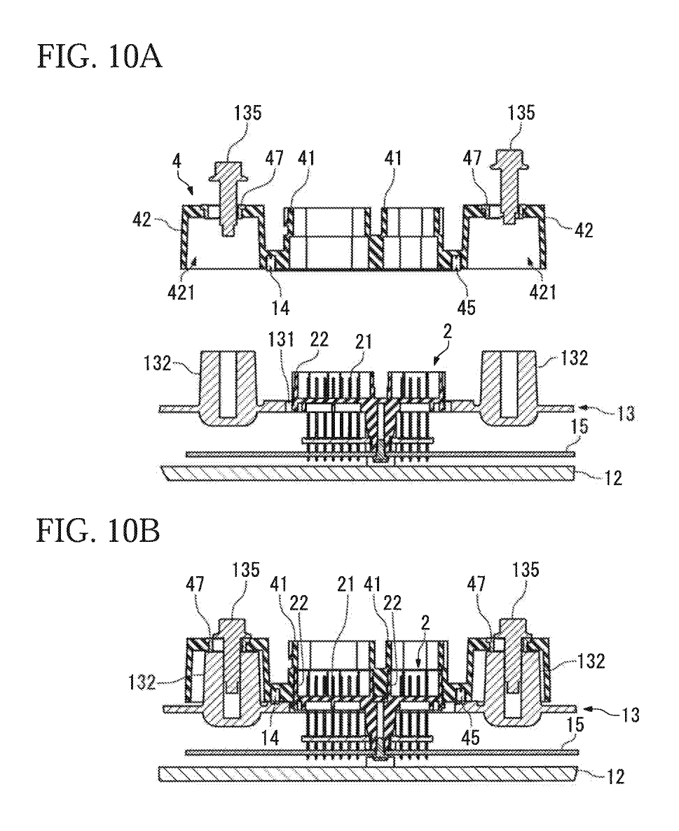

Next, as shown in FIGS. 7B and 8B, the cover housing 13 is placed. While positioning the main body receiving portion 22 to the connector placement window 131, the main body receiving portion 22 is inserted into the connector placement window 131. When the cover housing 13 is mounted to a certain position of the support plate 12 as shown in FIG. 2, the front end side of the connector body 2 protrudes from the connector placement window 131 to the outside of the cover housing 13, as shown in FIGS. 9A and 10A.

Further, the outer housing 4 is assembled to the cover housing 13. At this time, as shown in FIGS. 9A and 10A, the projection 132 of the cover housing 13 protrudes to the front from the front end of the main body receiving portion 22 so that the projection 132 can be covered with the guide cylinder 42 in preference to other parts. Accordingly, the projection 132 and the guide cylinder 42 are guided to each other to facilitate assembly of the outer housing 4 to the cover housing 13. Eventually, as shown in FIGS. 9B and 10B, the outer housing 4 is pressed so as that the main body receiving portion 22 is accommodated in the outer receiving portion 41, and thereby the clearances C1, C2 as shown in FIG. 2 are provided between the main body receiving portion 22 and the outer receiving portion 41.

Then, the bolt 135 is inserted in the collar 47 of the outer housing 4 to be fastened to the projection 132, to assemble the outer housing 4 to the outer housing 4 to the cover housing 13 of the case 11 to complete the water-proof connector 1.

According to the water-proof connector 1 as described above, the effects as described below can be achieved.

In the water-proof connector 1, the outer housing 4 assembled to the case 11 is used, and with the space S3 between the collar 47 and the bolt 135, the space S2 between the case 11 (the projection 132) and the outer housing 4 (the guide cylinder 42), and the clearances C1, C2 between the connector body 2 (the main body receiving portion 22) and the outer housing 4 (the outer receiving portion 41), the assembly tolerance between the case 11 (the connector placement window 131) and the connector body 2 (the main body receiving portion 22) can be absorbed. Thus, even if the position of the connector placement window 131 and the position of the connector body 2 are slightly shifted from each other depending on the positional accuracy of the circuit board 15 on the support plate 12, the water-proof connector 1 can be assembled without difficulty. In other words, measurement accuracy and assembly accuracy are not required to a large extent for the case 11, the outer housing 4 and the connector body 2.

Furthermore, since the mating connector 3 is fitted to the outer housing 4 (the outer receiving portion 41), the load applied when connecting the mating connector 3 and the load applied to the outer housing 4 in assembling do not directly act on the connector body 2, and thereby the circuit board 15 and the circuit elements mounted thereon can be prevented from being deformed or damaged due to the loads.

With the main body receiving portion 22 accommodated in the outer receiving portion 41 and the housing 31 of the mating connector 3 is fitted (in a sealed state with the seal member 14) in the outer receiving portion 41, water can be prevented from entering the space between the outer receiving portion 41 and the housing 31. Also, the boundary between the main body receiving portion 22 and the outer receiving portion 41 is located at the rear end side from the seal member 36, that is, at the downstream side of a passage through which water would enter. Therefore, even if a seal member is not provided between the main body receiving portion 22 and the outer receiving portion 41, water does not enter the space between the main body receiving portion 22 and the outer receiving portion 41. As such, in the water-proof connector 1, the case 11 can be waterproofed only with the seal member 14 provided between the outer housing 4 and the cover housing 13. Therefore, a seal member normally required for the space between the main body receiving portion 22 and the outer receiving portion 41 is omitted, thereby reducing cost.

Since the seal member 14 is covered with the cover portion 40 of the outer housing 4, water does not directly reach the seal member 14. Thus, high waterproofness can be ensured. Further, with the seal member 14 covered with the cover portion 40, dust or the like is prevented from being attached to the boundary between the seal member 14, the cover housing 13 and the cover portion 40 that could degrade the sealing capability. Therefore, waterproofness is improved.

Since the seal surface 13A to which the seal member 14 is provided is taller than the reference surface 13B, that is, the position of the seal surface 13A is higher in the vertical direction, water can be prevented from entering to the seal surface 13A from the reference surface 13B side (the outside of the seal member 14). Further, water staying around the seal member 14 is prone to be discharged toward the reference surface 13B. Such configurations also can improve waterproofness of the inside of the case 11.

Furthermore, when water stays in the inside (the convex portion formed by the collar 47 and the top surface 132F of the projection 132) of the collar 48, water can be discharged from the notch 471 of the collar 47. Therefore, the bolt 135, the projection 132 and the collar 47 made of metal can be protected from corrosion, and the fastening state of the bolt 135 and the projection 132 can be maintained in a stable manner.

Still further, the outer housing 4 is reinforced by the ribs 43, 44, and thereby deformation such as warpage prone to occur in the elongated-shaped outer housing 4 can be suppressed. As a result, the sealing state between the outer housing 4 and the cover housing 13 is maintained, and waterproofness against environmental loads is attained in a stable manner.

When assembling the outer housing 4 to the case 11, the outer housing 4 is guided with respect to the case 11 by way of the mutual guiding functions of the projection 132 of the case 11 and the guide cylinder 42 of the outer housing 4, thereby improving assembly workability.

Furthermore, with the joint end 21A side of the contact 21 covered with the wall body 25 of the connector body 2, heat due to pre-heating does not immediately dissipate after the pre-heating is stopped but stays at the area to be soldered. Therefore, the soldering can be performed in an expedite manner.

Still further, while soldering is performed, air heated by soldering is rectified through the space S1 partitioned by the fin 251 and is discharged from the upper outlet 252 in an effective manner, and thereby the connector body 2 and the circuit board 15 are prevented from being deformed or damaged due to excessive residual heat.

Although the invention has been described based on the embodiments above, the configurations described in the above embodiments can be appropriately omitted or modified without departing from the spirit of the invention.

What is claimed is:

1. A water-proof connector comprising:
a connector body having:
(a) a contact for establishing an electrical connection with a mating connector, and
(b) a main body housing having a main body receiving portion for holding the contact and receiving the mating connector; and
an outer housing surrounding the connector body and adapted for attachment to a case containing a circuit board and having an outer receiving portion in which the main body receiving portion is positioned for receiving the mating connector.

2. A water-proof connector according to claim 1 further including a seal member positioned on the outside of the outer receiving portion which forms a seal between the outer receiving portion and the case is attached to the outer housing.

3. A water-proof connector according to claim 2 further including an alignment guide mounted to the outer receiving portion and adapted to engage a corresponding alignment guide mounted to the case when the case is attached to the outer housing.

4. A water-proof connector according to claim 3 wherein the alignment guide mounted to the case includes a projection and the alignment guide mounted to the outer receiving portion includes a cylinder in which the projection is received.

5. A water-proof connector according to claim 3 wherein the alignment guide mounted to the case includes a pair of projections and the alignment guide mounted to the outer receiving portion includes a pair of cylinders in which the pair of projections are received.

6. A water-proof connector according to claim 2 wherein the surface of the outside receiving portion at which the seal is positioned has a greater height that the surface that surrounds the surface of the seal member.

7. A water-proof connector according to claim 3 further including a fastener that extends through the alignment guide mounted to the outer receiving portion and is adapted to engage a corresponding alignment guide mounted to the case.
